(19) United States
(12) Patent Application Publication
(10) Pub. No.: US 2003/0092321 A1
(43) Pub. Date: May 15, 2003

(54) Arrangement for attaching a plug-in connector to a shielded electric line

(75) Inventors: Friedrich Schauer, Heroldsberg (DE); Martin Czeschka, Hilpoltstein (DE)

Correspondence Address: SUGHRUE MION, PLLC, 2100 Pennsylvania Avenue, NW, Washington, DC, 20037-3213, US

(73) Assignee: NEXANS

(21) Appl. No.: 10/290,267

(22) Filed: Nov. 8, 2002

(30) Foreign Application Priority Data
Nov. 10, 2001 (DE) 10155409.5

(51) Int. Cl. H01R 9/03

(52) U.S. Cl. 439/610

(57) ABSTRACT

In an arrangement for attaching a plug-in connector to a shielded electric line, a shield including a braid made of metallic wires is applied over the insulated conductor and the shield is surrounded by a sheath made of insulating material. A tubular, metallic contact element is provided, against the external surface of which the shield of the line presses all around and through which the core of the line is guided. The plug-in connector is positioned in a pot-shaped metallic housing, which encloses the plug-in connector along its entire length and leaves its plug side free. The contact element is implemented as a tube connector, which projects through the wall of the housing and has an extension attached to its end, which presses against the wall tightly and solidly. The shield is fixed to the housing via a crimp sleeve attached over the tube connector projecting from the housing.

This application is based on and claims the benefit of German Patent Application No. 10155409.5 filed Nov. 10, 2001, which is incorporated by reference herein.

### SUMMARY OF THE INVENTION

The invention relates to an arrangement for attaching a plug-in connector to a shielded electric line, over whose core, which has at least one insulated conductor, a shield comprising a braid made of metallic wires is applied. The shield is enclosed by a sheath made of insulating material, and the shielded electric line has a tubular, metallic contact element against whose external surface the shield of the line presses all around and through which the core of the line is guided. An example of such an arrangement is shown in European Patent Application 1 095 429 A1.

Shielded electric lines are used where interference-free signal transmission is necessary. For example, they are connected to electronic devices, such as oscillographs, measuring devices, or control devices. The shield of such a line may not be interrupted at the point of entrance of the line into the corresponding device. This is also true if a part of a plug-in connector, which is to be plugged into a device or is to be plugged together with a complementary part of the plug-in connector, is attached to the end of the line. The shield must be maintained even in the region of a plug-in connection of this type.

In the arrangement known from German Patent 32 42 073 C2, a shielded line is introduced into a metallic housing of an electrical device. The shield of the line, which is implemented as a braid, lies on the outside of a contact element, implemented as a tube in this case. A crimp sleeve, which fixes the shield on the tube, is positioned over the shield. The end of the line is embedded moisture-tight in a protective body made of insulating material produced by injection molding. The tube, which projects through the wall of the housing, has a threaded connector. In the mounting position, it is fixed inside the housing by a nut screwed onto the threaded connector. The insulated conductor of the line then projects through the tube into the housing.

In the known arrangement according to European Patent Application 1 095 429 A1 cited above, a metallic tubular piece is positioned between the core of the line and the shield surrounding it, in a region surrounded by the sheath made of insulating material. The shield, which is stripped on its end, is bent back in such a way that it presses externally onto the sheath. A metallic sleeve, which projects over the line, whose rear end is deformable, and whose front end presses against the tubular piece, is attached via the tubular piece and the sheath of the line, which has a shield pressing against its exterior. The sleeve is compressed onto the mantle of the line, which has the shield and the tubular piece lying underneath it, by a union nut screwed onto its deformable free end. The reliability of this known arrangement is essentially a function of the strength and stability of the sheath. It is therefore not guaranteed over a long period, since the material of the sheath yields relatively quickly to the pressure load acting on it. The many parts of the arrangement then loosen and the shielding is interrupted.

### SUMMARY OF THE INVENTION

It is an object of the present invention to design an arrangement of the type described above in such a way that it has stability over a long period with completely effective shielding.

This object is achieved according to the invention in that,

the plug-in connector is positioned in a pot-shaped metallic housing, which surrounds it over its entire length and leaves its plug side free,

the contact element is implemented as a tube connector projecting through the wall of the housing, to whose end lying in the housing an extension is attached, which abuts to the wall tightly and solidly,

the shield is fixed to the tube connector via a crimp sleeve attached to the tube connector projecting from the housing.

This arrangement has a simple construction and is easy to handle. To attach the line to the metallic housing of the plug-in connector, the contact element must only be pushed through a hole present in the wall of the housing in such a way that its peripheral extension abuts tightly and solidly to the wall. The conductor and shield of the line are freed from their sheath, which is made of insulating material. The conductor is pushed through the tube connector of the contact element, which projects out of the housing. The shield is simultaneously pushed onto the outside of the tube connector. The crimp sleeve, which is preferably pushed onto the line previously, is then brought into position until it abuts to the wall of the housing and is crimped around the shield and tube connector in this position. The shield is thus fixed on the contact element and the contact element itself is connected to the housing and attached to its wall without additional attachment means. Since the shield abuts directly to the tube connector and the crimp sleeve is attached directly over the shield, an arrangement which is solid for long period and has secure shielding of line and plug-in connector results.

The crimp sleeve may extend up to over the sheath of the line if it has a corresponding length. However, it is also possible to apply shrinkable tubing, which presses against a shorter crimp sleeve and against the sheath of the line.

### BRIEF DESCRIPTION OF THE DRAWINGS

Exemplary embodiments of the object of the invention are illustrated in the drawing.

FIG. 1 shows the arrangement according to the invention in a schematic illustration.

FIG. 2 shows a detail of the arrangement in an enlarged illustration.

FIG. 3 shows a section through FIG. 2 along line III-III.

FIG. 4 shows an embodiment altered in relation to FIG. 2.

### DETAILED DESCRIPTION OF THE INVENTION

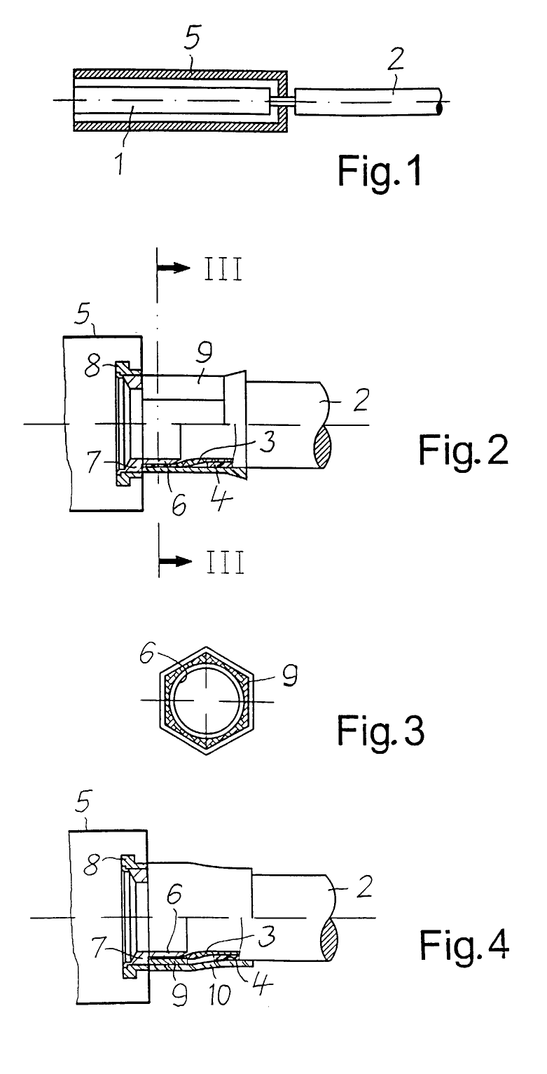

A plug-in connector 1, which is a part of an electric plug-in connection, is schematically illustrated in FIG. 1. Plug-in connector 1 may be equipped with plug pins or socket contacts. A shielded electric line 2, which has at least one insulated electric conductor (wire), is attached to plug-in connector 1. Line 2 typically has two or more wires, which, possibly with additional sheaths, form the core of line 2. This line 2 is surrounded by shield 3 implemented as a braid made of metallic wires, particularly copper wires, over which a sheath 4 made of insulating material is applied (FIGS. 2 and 4). Plug-in connector 1 is enclosed by a pot-shaped, metallic housing 5, which only leaves its plug side free. The housing is made of zinc, for example. Line 2 and/or its core is guided through the wall of housing 5.

The connection of shield 3 of line 2 to housing 5 will now be described with reference to FIGS. 2 to 4, in which only the parts of line 2 necessary for understanding the arrangement are illustrated:

A contact element implemented as a tube connector 6 is used to introduce line 2 and/or its core into housing 5. Tube connector 6 is made of steel and/or stainless steel, for example. It is simultaneously used for the connection of shield 3 of line 2 to metallic housing 5 and therefore for the reliable through-connection of the shielding. On its end lying inside housing 5, the tube connector has an extension 7, preferably protruding outward with a perpendicular transition, which abuts tightly and solidly to the wall of housing 5. This may be achieved, for example, by a crimp ring 8 made of zinc, which is compressed onto the outside of extension 7. Crimp ring 8 may also, however, be implemented in one piece with extension 7 of tube connector 6.

Tube connector 6 projects out of housing 5. Shield 3 of line 2 abuts all around against its outer lateral surface. The shield is fixed against tube connector 6 by a crimp sleeve 9, made of brass or copper, for example, which presses directly against shield 3 and compresses the shield onto tube connector 6. One face of crimp sleeve 9 also preferably abuts tightly to the wall of housing 5. The crimp sleeve is primarily used for a solid connection of shield 3 and tube connector 6 and, in combination with extension 7 of tube connector 6, to reinforce the connection onto housing 5. After the compression, crimp sleeve 9 may, for example, have a hexagonal cross-section as shown in FIG. 3.

As shown in FIG. 2, crimp sleeve 9 may be so long that it projects up to over sheath 4 of line 2. It is then also crimped with this sheath. In this way, sheath 4 is held on the connection point in a simple way so that it cannot slip away.

As an alternative to the embodiment shown in FIG. 2, a short crimp sleeve 9 may also be used, as shown in FIG. 4. In this case, shrinkable tubing 10, made of a material which shrinks when heat is supplied, may additionally be used, which presses against crimp sleeve 9 and extends up to over sheath 4 of line 2. Sheath 4 is fixed onto the connection point in this way as well. Shrinkable tubing 10 may also be provided with markings on its outer surface.

The arrangement according to the invention is produced as follows, for example:

Tube connector 6 is pushed through a hole in the wall of housing 5 and, for example, attached thereto using crimp ring 8. The end of line 2 and/or its core is then pushed through tube connector 6 and attached thereto. For this purpose, sheath 4 of line 2 is removed for a predetermined length. Shield 3 exposed in this way is then shortened/removed enough that the wire(s) of the core of line 2 project(s) a sufficient length out of the line. As the core of line 2 is pushed through tube connector 6, shield 3 is simultaneously pushed onto the outside of tube connector 6. In this case, shield 3 is expanded somewhat due to the larger external diameter of tube connector 6, so that it presses solidly against the tube connector. This is made easier by a conically-shaped end of tube connector 6, as is shown in FIGS. 2 and 4. Crimp sleeve 9 previously pushed onto line 2 is then positioned and crimped with shield 3 and possibly sheath 4 of line 2.

What is claimed is:

1. An arrangement for attaching a plug-in connector to a shielded electric line, said line having a core with at least one insulated conductor, a shield comprising a braid made of metallic wires applied over said core, a sheath made of insulating material enclosing the shield, and a tubular, metallic contact element, against the external surface of which the shield of the line abuts all around and through which the core of the line is guided, said arrangement characterized in that:
the plug-in connector includes a plug side and is positioned in a pot-shaped metallic housing which surrounds the plug-in connector over its entire length and leaves said plug side free,
the contact element comprises a tube connector projecting through a wall of the housing, said tube connector having an end lying in the housing and having an extension attached thereto, said extension pressing against the wall tightly and solidly, and
the shield is fixed to the housing via a crimp sleeve attached over the tube connector projecting out of the housing.

2. The arrangement according to claim 1, characterized in that the crimp sleeve abuts tightly to an outside of the wall of the housing.

3. The arrangement according to claim 1, characterized in that the extension protrudes outwards with a perpendicular transition from the tube connector.

4. The arrangement according to claim 1, characterized in a free end of the crimp sleeve extends over the sheath of the line.

5. The arrangement according to claim 1, characterized in that shrinkable tubing, made of a material which shrinks when heat is supplied, extends over the sheath of the line and is positioned over the crimp sleeve.

6. The arrangement according to claim 1, characterized in that tube connector and extension, as well as a crimp ring surrounding them on the outside, are manufactured in one piece.
